(19) United States
(12) Patent Application Publication
(10) Pub. No.: US 2008/0260217 A1
(43) Pub. Date: Oct. 23, 2008

(54) System and method for designating a boundary of a vessel in an image

(76) Inventor: Adi Mashiach, Tel Aviv (IL)

Correspondence Address: EITAN MEHULAL LAW GROUP, 116 John St, Suite 1201, New York, NY, 10038, US

(21) Appl. No.: 11/785,970

(22) Filed: Apr. 23, 2007

(51) Int. Cl. G06K 9/00

(52) U.S. Cl. 382/128

(57) ABSTRACT

A method and system of applying a fitting function to an element in an image, and determining the segments of the element that are included in an boundary of a blood vessel in the image.

### BACKGROUND OF THE INVENTION

Differentiating a shape, boundary or structure of a vessel or other object in an image of a body party such as an image generated by a CT, MRI or other imaging system, may be complicated by the appearance in the image of structures that may overlap or are contiguous to the vessel being identified. In some images, contiguous structures may create blurred lines between the boundaries of a vessel and the bones, organs or other vessels near the vessel being identified. Manual identification of such a boundary or shape of the vessel may prove complicated or impossible.

### SUMMARY OF INVENTION

In some embodiments, the invention includes a method of designating segments of a vessel boundary in an image that may include a vessel such as a blood vessel, applying a fitting function to a first of segment when connected to a second of segment; applying the fitting function to the first segment when connected to a third segment; and comparing a fit of the connected first and second segments with a fit of a the connected first and third segments.

In some embodiments, a method may include selecting a pair of segments from among first and second segments on the one hand, and the first and third segments on the other hand, as the pair having a fit closest to a pre-defined shape.

In some embodiments, a method may include applying the fitting function to the selected pair of segments with a fourth segment.

In some embodiments, a method may include designating the first segment and the second segment as an expanded first segment, and applying the fitting function to the expanded first segment and the third segment, and comparing an error fit of the expanded first segment with the third segment with an error fit of the expanded first segment alone.

In some embodiments, a method may include tracing pixels of the boundary into a set of curved lines, detecting a turning point on a curve of the curved lines, and designating the turning point as an end of a segment.

In some embodiments, a method may include applying a linear regression to pixels on a curve.

In some embodiments, a method may include selecting a pixel having a local maximum distance from a selected curve after applying a linear regression to pixels in an area of the curve.

In some embodiments, a method may include applying a threshholding process to pixels in the image, applying a first clustering to such pixels, and applying a second clustering to such pixels.

In some embodiments, a method may include defining a cluster center so that a cluster of pixels in the image includes pixels in the boundary of the vessel, clustering pixels around the cluster center, and defining a cluster of pixels as including the boundary of the vessel.

In some embodiments, a method may include designating an element in an image into a set of segments, comparing a combination of at least two segments of the set of segments to a pre-defined form, selecting a combination of segments based on a result of the comparison, and assembling the combination segments into a boundary of a blood vessel appearing in the image.

In some embodiments, a method may include designating an area of interest in the image that includes the boundary of the blood vessel, clustering pixels in the area of interest of the image in a first clustering process, clustering a portion of such clustered pixels in a second clustering process, identifying from the second clustering, a cluster, of pixels that includes the boundary of the vessel, and designating a line of the boundary from the cluster of pixels.

In some embodiments, a method may include identifying a local maximum distance of a pixel from the line.

### BRIEF DESCRIPTION OF THE FIGURES

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of an image processing device and system, in accordance with an embodiment of the invention;

FIG. 2 is a schematic depiction of one or more images of a body part captured by an ex vivo imager, in accordance with an embodiment of the invention;

FIG. 3 is a schematic diagram of clustered pixels tracing a line that may represent a wall or boundary of a vessel in accordance with an embodiment of the invention;

FIG. 4 is a schematic diagram of a result of a shape fitting function applied to a segment of an element in an image, in accordance with an embodiment of the invention; and

FIG. 5 is a flow diagram of a method in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “processing,” “computing” “calculating,” “determining,” or the like, may refer to the actions and/or processes of a computer, computer processor or computing system, or similar electronic computing device, that may manipulate and/or transform data represented as physical, such as electronic, quantities within the computing system's registers and/or memories into other data similarly, represented as physical quantities within the computing system's memories, registers or other such information storage, transmission or display devices. In some embodiments processing, computing, calculating, determining, and other data manipulations may be performed by one or more processors that may in some embodiments be linked.

The processes and functions presented herein are not inherently related to any particular computer, imager, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein.

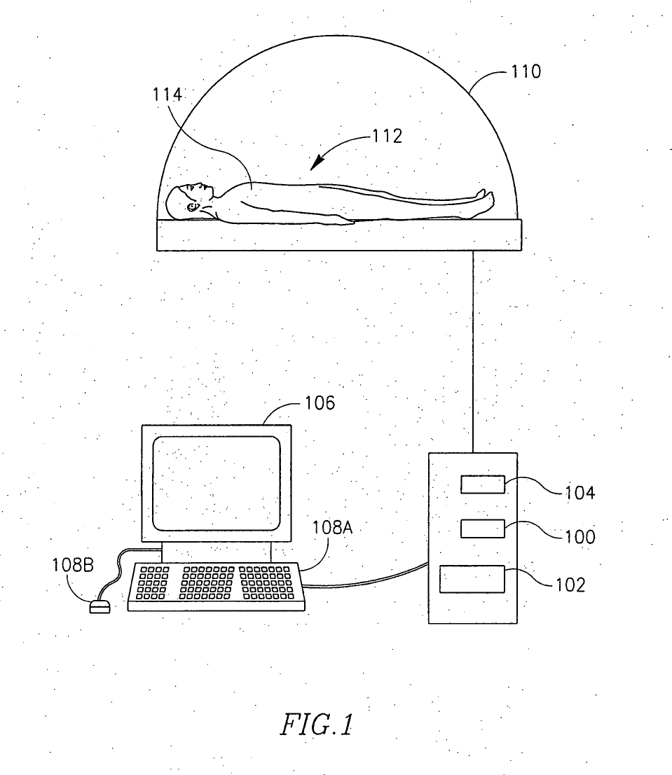

Reference is made to FIG. 1, a schematic diagram of an image processing device and system, in accordance with an embodiment of the invention. An image processing device in accordance with an embodiment of the invention may be or include a processor 100 such as for example a central processing unit. The image processing device may include or be connected to a memory unit 102 such as a hard drive, random access memory, read only memory or other mass data storage unit. In some embodiments, processor 100 may include or be connected to a magnetic disk drives 104 such as may be used with a floppy disc, disc on key of other storage device. The image processor may include or be connected to one or more displays 106 and to an input device 108 such as for example a key board 108A, a mouse, or other pointing device 108B or input device by which for example, a user may indicate to a processor 100 a selection or area that may be shown on a display. In some embodiments, processor 100 may be adapted to execute a computer program or other instructions so as to perform a method in accordance with embodiments of the invention.

The processor 100 may be connected to an external or ex vivo diagnostic imager 110, such as for example a computerized tomography (CT) device, magnetic resonance (MR) device, ultrasound scanner, CT Angiogaphy, magnetic resonance angiograph, positron emission tomography or other imagers 110. In some embodiments, imager 110 may capture one or more images of a body 112 or body part such as for example a blood vessel 114, a tree of blood vessels, alimentary canal, urinary tract, reproductive tract, or other tubular vessels or receptacles. In some embodiments imager 110 or processor 100 may combine one or more images or series of images to create a 3D image or volumetric data set of an area of interest of a body or body part such as for example a blood vessel 114. In some embodiments, a body part may include a urinary tract, a reproductive tract, a bile duct, nerve or other tubular part or organ that may for example normally be filled or contain a body fluid. In some embodiments, imager 110 and/or processor 100 may be connected to a display 106 such as a monitor, screen, or projector upon which one or more images may be displayed or viewed by a user.

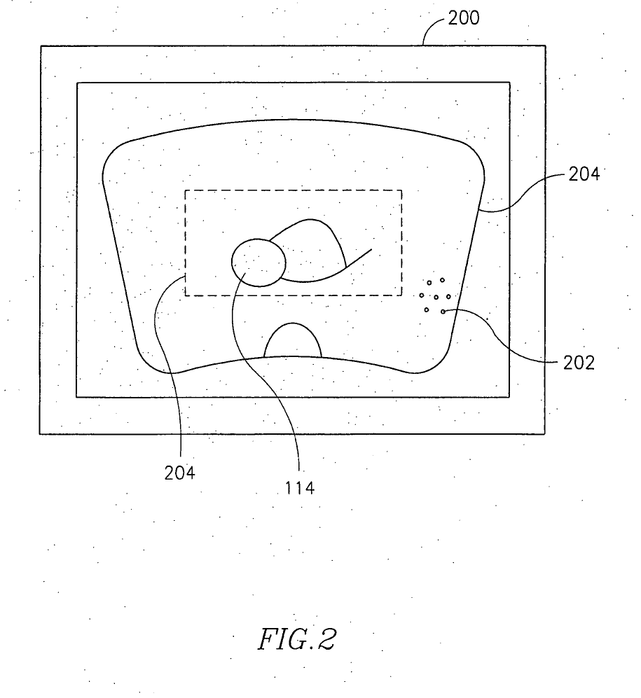

Reference is made to FIG. 2, a depiction of an image in accordance with an embodiment of the invention. In some embodiments, image 200 may be one or more of a series of images of for example a slice of a body or body parts 204 that may be captured by an ex vivo imager. In some embodiments, one or more of such images 200 may be arranged for example in an order that may, when such images 200 are stacked, joined or fused by for example a processor, create a three dimensional view of a body part such as a blood vessel 114, or provide volumetric data on a body part or structure. In some embodiments images 200 in a series of images may be numbered sequentially or otherwise ordered in a defined sequence. In some embodiments, images 200 may include an arrangement, matrix or collection of pixels 202, voxels or other atomistic units that may, when combined create an image. In some embodiments, pixels 202 may exhibit, characterize, display or manifest an image intensity of the body part appearing in the area of the image 200 corresponding to the pixel 202. In some embodiments, an image intensity of a pixel 202 may be measured in Hounsfield units (HU) or in other units.

In some embodiments, a location of a pixel 202 in an image 200 may be expressed as a function of coordinates of the position of the pixel on a horizontal (x) and/or vertical (y) axis. Other expressions of location, intensity and characteristics may be used.

In some embodiments, a user of an image processing device or system may view an image 200 on for example display 106, and may point to or otherwise designate an area of the image 200 as for example a region of interest 204 within the image. In some embodiments, a region of interest 204 may be or include a location within an image 200 of a body part such as for example a vessel 114 or other structure or organ in a body.

In some embodiments, an initial threshholding of an image or area of an image into several Hu groups may remove pixels or areas of pixels having image intensities of less than a defined Hu level. Such a defined level may approximate an image intensity level of pixels that correspond to for example areas of water or air or other items in an image with low Hu intensity levels that are not of interest to a particular exercise or evaluation. Similarly, a threshholding may designate and for example exclude bright areas such as calcified areas that have Hu levels that are higher than for example those associated with soft tissue such as a wall of a vessel.

Pixels 202 or an area of an image that were not removed in a first or prior thresholding may be subject to a second or subsequent threshholding that may divide the remaining pixels 202 into many groups of Hu levels. For example, the remaining pixels 202 which may approximate the Hu levels of soft tissue, may be threshholded into 10, 15 or even more groups. The threshholded groups may be clustered. In some embodiments, some or all of the pixels 202 that had been excluded following for example a first threshholding as having Hu levels that were below a pre-defined minimum level (such as those representing air or water) and pixels 202 that were above a pre-defined maximum level (such as those representing calcified areas) may be re-added to the image as binary areas of black for low end pixels and white for high end pixels. Other methods of display of such re-added pixels are possible.

In some embodiments, an area of an image may be designated as one that likely represents soft tissue and that likely includes a wall or boundary of a vessel such as a blood vessel. For example, an area of an image may be selected that includes for example blood, as such area may have been isolated, and for example blacked-out in a first or prior threshholding process, and that includes for example a calcified area such as a bone or calcified portion of a vessel, as such area may have been isolated or whited-out in a prior threshholding process. The selected space in between such blacked-out area and whited-out area may be assumed to include soft tissue such as for example a wall or boundary of a vessel.

In some embodiments, certain clusters of pixels 202 may be mapped into regions of isolable contour levels, where a mapped region shows an area of a cluster of pixels 202 having a given range of image intensities. In some embodiments, the isolable contour region that has a range of image intensity levels which is the same as or similar to the range of image intensity levels of a boundary or wall of vessel may be identified.

In some embodiments, a selection of one among a plurality of possible isolable contours regions that may define a boundary of a target vessel, may be made by for example comparing, geometric characteristics of a view of for example a target vessel or other area as it is presented in for example two or more isolable contour regions. In some embodiments, the accuracy of the selection of an isolable contour region that defines a boundary of a target vessel may also be checked through texture analysis of a target vessel as the vessel is presented in various images having areas of interests of different sizes. In some embodiments, the sharpness or definition or accuracy of definition of a target vessel or organ identified in the process of differentiating a vessel, may be checked, optimized or improved by first standardizing the size or number of pixels in a particular area of interest of an image by for example standardizing the entropy figure by diving the entropy figure by a log of the number of pixels in the area whose entropy is measured, and comparing the standardized entropy of an area of interest in a first image to a standardized entropy in an area of interest of another image.

In some embodiments, a boundary of a most relevant isolable contour as determined by for example texture analysis or geometric properties, may be deemed or assumed to represent a boundary of a vessel.

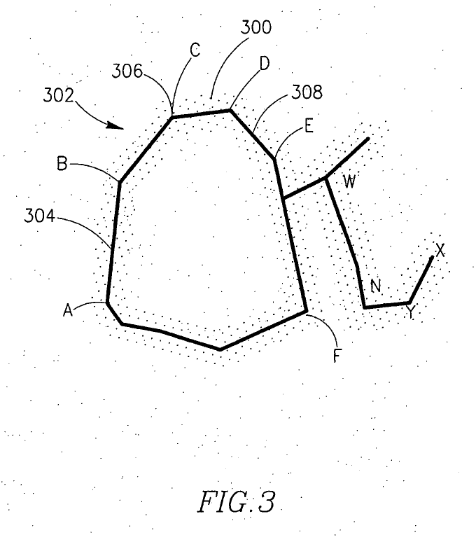

Reference is made to FIG. 3, a schematic diagram of clustered pixels tracing a line that may represent a wall or boundary of a vessel in accordance with an embodiment of the invention. In some embodiments, when a cluster of pixels 300 has been defined that includes the pixels of a wall or boundary of a vessel, a tracing process may be performed on such cluster of pixels 300 to create a line or image element 302 that may represent a wall or boundary of a vessel. In such tracing process, the x and y coordinates of such pixels may be plotted so that for example a relatively continuous line of pixels may trace what may be the walls or boundaries of one or more blood vessels that appear in the area of the image that was subject of the tracing process.

In some embodiments, a linear or other regression or noise minimizing function may be applied to the cluster of pixels used to generate the line, in order to remove or reduce noise or outlying pixels from the traced line. For example, in some embodiments, a regression may be performed on pixels that may stray from the line which defines or may represent the traced wall or boundary of a vessel. In some embodiments, some or most of the outlying pixels may be disregarded or regressed into the traced line. In some embodiments, a processor may designate, draw or trace a line 304 onto or over the image, to represent the regressed pixels that may be included in the wall or boundary of the vessel.

In some embodiments, a traced line may be divided or broken up into a series of arcs or segments 308. The size and number of arcs or segments 308 may vary, and in some embodiments a user or other operator may define for example a maximum or minimum number, size and other characteristics of the arcs or line segments 308. In some embodiments, an end point of an arc or line segment 308 of a traced line may be selected by identifying for example one or more pixels that define a maximum of a standardized divergence of points along a traced boundary from a regressed line around such points. For example, an end 306 of an arc or line segment 308 may be derived through an algorithm such as for example End Point Pixels (P)=Σdi, where di is the distance of one or more pixels from the traced line 304 and Σ is the standardized sum of the minimum distance of one or more pixels 300 from line 304. For example, and referring to FIG. 3, arc AB may represent a segment 308 around which pixels may have been regressed. A standardized sum of distances d of pixels (i) 300 surrounding line 304 may reach a local maximum at arc end point B where the outlying pixels begin to regress around a segment having for example a new or different slope. In some embodiments, a turning point of an arc may be deemed to be a local maximum of the standardized distances of pixels from the regressed line. Other methods of identifying or breaking up line 304 into segments 308 may be used. Similarly, other methods of finding end points 306 of a segment 308 are possible.

In some embodiments, a starting point A of an arc or line segment that may represent a wall or boundary of a vessel may be paired with for example a first or closest turning or end point 306 along such line to form a first arc AB. A next arc BC may be identified by selecting for example a next turning or end point 306 C, and pairing it with a previous terminal or turning point B of line 304. In some embodiments coordinates of some or all of the arcs or segments 308 that may define, among other things, a vessel wall or boundary in an image may be collected and stored in for example a memory connected to a processor.

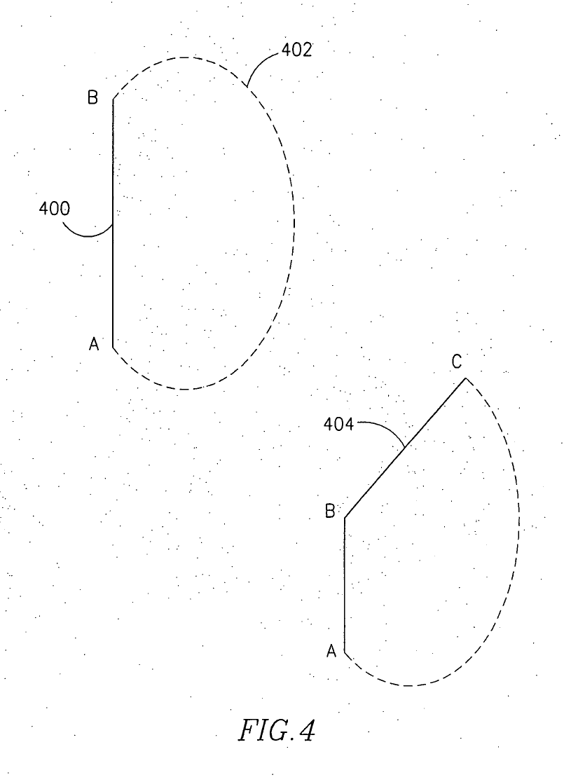

In some embodiments, an ellipse fitting or other shape fitting function may be used to assemble the collected segments 308 into shapes that may represent a recognizable or complete outline of the boundaries of one or more vessel. For example, and referring to FIG. 4, in some embodiments, an ellipse fitting function or other shape fitting function may be applied to a segment 308 such as arc AB, and a rang of the fit 402 of arc AB 400 to an ellipse or other shape may be collected. A same process may be performed on the combined arcs AB BC, AB CD, AB DE, AB EF, and AB FA. A comparison of the ranking of a fit of each of such arc combinations may be made to the fit of arc AB. If the ellipse fit ranking of one of the combined arcs when combined with arc AB is greater than the ellipse fit ranking of arc AB alone, then the highest ranking combined arc may be designated as a new or expanded base line arc 404 ABC. This process may be repeated by for example combining one or more of the remaining arcs with the new or expanded base line arc 404 and finding an ellipse fit that ranks higher than the ranking of the base line arc 404. The process may be repeated until all or some of the arcs that constitute an ellipse or other pre-defined shape have been combined into a base line arc 404. The base line arc 404 may be said to constitute the combination of the arcs of the traced line that make up a boundary of a vessel in an image. Referring back to FIG. 3, arcs WZ, ZY and YX would most likely not increase a ranking of a fit of a base line arc that includes arc AB and therefore would not be included in the base line arc 404. Such segments may be assumed to be part of a contiguous organ or of another vessel that may overlap with or be contiguous to the subject vessel.

In some embodiments, shapes other than ellipses may be used as a basis of comparison of segments or arcs to a vessel boundary. For example, empiric data may be collected that may define a shape or structure of one or more particular vessels, and comparisons of shapes or structures in an image may be made to a fit of the structure with the defined data.

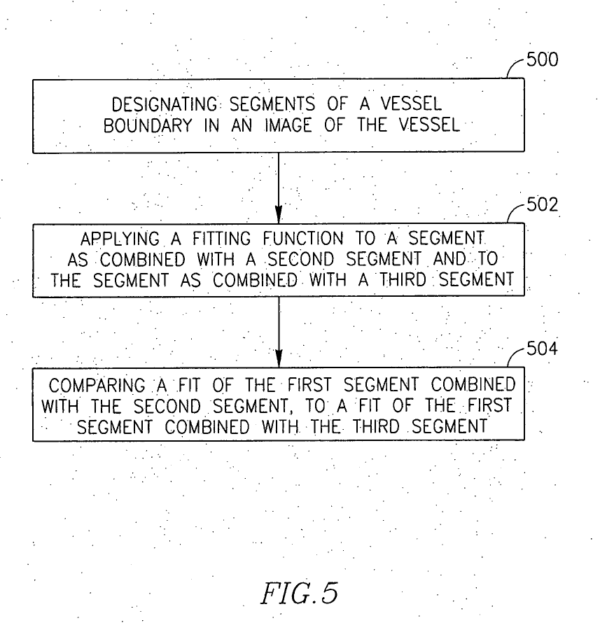

Reference is made to FIG. 5, a flow diagram of a method in accordance with an embodiment of the invention. In block 500, there may be designated one or more segments of a boundary of a vessel in an image of the vessel. For example, an image may include one or more boundaries of one or more vessels or other structures of a body that may appear in the image. The one or more boundaries may be divided or separated into segments. In block 502, a form fitting function such as for example an ellipse fitting function or other shape fitting function may be applied to one or more combinations of segments such as for example a first segment and a second segment, and for example a first segment and a third segment. A ranking of the fit of the various combined sections may be derived. In block 504, a comparison may be made of a form fitting rank of the first segment or combination of segments with the second segment or combination of segments. For example, a comparison of a form fit may be made between a first segment with a second segment and a first segment with a third segment.

In some embodiments, the segment or combination of segments that is selected as having the closest match or fit to the pre-defined shape may be designated as being part of a structure having such shape. For example, if the combination of segment AB and segment BC has a fit ranking that is closer to a fit of other segments when combined with segment AB, then the combination of segment AB and segment BC may be deemed or assumed to be part of a particular structure that is being ranked against the pre-defined shape. Other segments may be added to the expanded segments AB and BC, and the process of ranking a fit and comparing the fit with other combinations may be repeated with for example a third, fourth and other segments.

In some embodiments, a first segment AB may be designated, for example arbitrarily or by other means, and the shape fitting function may be applied to such first segment AB with the resulting ranking compared to a rank of the combination of such first segment AB with one or more of the other segments. In some embodiments, the shape fitting function may be applied to some or all of the individual segments, and the segment with the highest fit ranking may be selected as an initial base line segment.

In some embodiments, one or more segments may be created by tracing pixels of a boundary or a vessel into an image element that may represent the wall or boundary. The image element may be broken or segmented into arcs or segments by defining or deriving one or more turning points on a curve of the image element. In some embodiments, pixels that may be included in an intensity level that characterized a vessel wall may be regressed, such as by a linear regression, or otherwise grouped around a line, curve or image element that may represent the vessel wall. The turning points of segments may define a beginning or end of a segment, and may in some embodiments be derived by locating a local maximum distance from a curve of the image element representing the wall or boundary of the vessel.

In some embodiments, a method of the invention may include designating segments of an element in an image, comparing a combination of at least two of the segments to pre-defined form, selecting the combined segments based on a result of the comparison produced by a form fitting function; and assembling the combination the segments into a representation of a boundary of a blood vessel.

It will be appreciated by persons skilled in the art that embodiments of the invention are not limited by what has been particularly shown and described hereinabove. Rather the scope of at least one embodiment of the invention is defined by the claims below.

I claim:

1. A method comprising:
designating a plurality of segments of a vessel boundary in an image of said vessel;
applying a fitting function to a first of said segments with a second of said segments;
applying said fitting function to said first segment with a third of said segments; and
comparing a fit of said first segment and said second segment, to a fit of said first segment with said third segment.

2. The method as in claim 1, comprising selecting a pair of segments from among said first segment with said second segment and said first segment with said third segment, said selected pair having a fit closest to a pre-defined shape.

3. The method as in claim 2, comprising applying said fitting function to said selected pair of segments with a fourth segment.

4. The method as in claim 1, comprising:
designating said first segment and said second segment as an expanded first segment;
applying said fitting function to said expanded first segment and said third segment;
comparing an error fit of said expanded first segment with said third segment with an error fit of said expanded first segment.

5. The method as in claim 1, wherein said designating said plurality of segments comprises:
tracing pixels of said boundary into a plurality of curves;
detecting a turning point on a curve of said plurality of curves; and
designating said turning point as an end of a segment of said plurality of segments.

6. The method as in claim 5, comprising applying a linear regression to pixels of said a curve of said plurality of curves.

7. The method as in claim 6, wherein said detecting said turning point comprises selecting a pixel having a local maximum distance from said curve after applying said linear regression to said pixels.

8. The method as in claim 1, comprising:
applying a threshholding process to pixels in said image;
applying a first clustering to said pixels; and
applying a second clustering to said pixels.

9. The method as in claim 1, comprising:
defining a cluster center so that a cluster of pixels in said image includes pixels in said boundary of said vessel;
clustering pixels around said cluster center; and
defining a cluster of pixels as including said boundary of said vessel.

10. A method comprising:
designating an element in an image into a plurality of segments;
comparing a combination of at least two segments of said plurality of segments to a pre-defined form;
selecting said combination based on a result of said comparison; and
assembling said combination of at least two segments into a boundary of a blood vessel appearing in said image.

11. The method as in claim 10, comprising:
designating an area of interest in said image that includes said boundary of said blood vessel;
clustering pixels in said image in a first clustering process;
clustering a portion of said pixels in said image in a second clustering process;
identifying from said second clustering a cluster of pixels that includes said boundary of said vessel; and
designating a line of said boundary from said cluster of pixels.

12. The method as in claim 11, wherein said designating segments of an element in an image comprises identifying a local maximum distance of a pixel from said line.

13. A system comprising a processor, said processor to:
designate a plurality of segments of a vessel boundary in an image of said vessel;
apply a fitting function to a first of said segments with a second of said segments;
apply said fitting function to said first segment with a third of said segments; and
compare a fit of said first segment and said second segment, to a fit of said first segment with said third segment.

14. The system as in claim 13, wherein said processor is to select a pair of segments from among said first segment with said second segment and said first segment with said third segment, said selected pair having a fit closest to a pre-defined shape.

15. The system as in claim 13, wherein said processor is to:
designate said first segment and said second segment as an expanded first segment;
applying said fitting function to said expanded first segment and said third segment;
comparing an error fit of said expanded first segment with said third segment with an error fit of said expanded first segment.

16. The system as in claim 13, wherein said processor is to:
trace pixels of said boundary into a curve of said boundary;
detect a turning point on said curve; and
designate said turning point as an end of a segment of said plurality of segments.

17. The system as in claim 16, wherein said processor is to apply a linear regression to pixels defining said curve.

18. The system as in claim 17, wherein said processor is to detect said turning point by selecting a pixel having a local maximum distance from said curve.

19. The system as in claim 13, wherein said processor is to:
apply a threshholding process to pixels in said image;
apply a first clustering to said pixels; and
apply a second clustering to said pixels.

20. The system as in claim 13, wherein said processor is to:
define a cluster center so that a cluster of pixels includes pixels in said boundary of said vessel;
cluster pixels around said cluster center; and
define a cluster of pixels as including said boundary of said vessel.
